(19) United States
(12) Patent Application Publication
(10) Pub. No.: US 2019/0317946 A1
(43) Pub. Date: Oct. 17, 2019

(54) METADATA PROCESSING METHOD, INFORMATION PROCESSING APPARATUS, AND RECORDING MEDIUM RECORDING METADATA PROCESSING PROGRAM

(71) Applicant: FUJITSU LIMITED, Kawasaki-shi (JP)

(72) Inventors: Shinichiro Tago, Shinagawa (JP); Fumihito NISHINO, Koto (JP)

(73) Assignee: FUJITSU LIMITED, Kawasaki-shi (JP)

(21) Appl. No.: 16/451,618

(22) Filed: Jun. 25, 2019

Related U.S. Application Data
(63) Continuation of application No. PCT/JP2017/046674, filed on Dec. 26, 2017.

(30) Foreign Application Priority Data
Jan. 10, 2017 (JP) 2017-002190

(51) Int. Cl. G06F 16/25; G06F 16/2457; G06F 16/28

(52) U.S. Cl. CPC G06F 16/258; G06F 16/284; G06F 16/254; G06F 16/24573

(57) ABSTRACT

A non-transitory computer-readable recording medium having stores therein a metadata processing program for causing a computer to execute a process including: extracting, based on comparison between a first input item name of first input data and a first output item name of first output data, an element other than an element included in both of the first input item name and the first output item name; and generating, when the extracted element and an argument of a program which generates the first output data from the first input data include an element related to a first input item value of the first input data, metadata in which the element related to the first input item value in the extracted element is transformed into a variable.

### CROSS-REFERENCE TO RELATED APPLICATION

This application is a continuation application of International Application PCT/JP2017/046674 filed on Dec. 26, 2017 and designated the U.S., the entire contents of which are incorporated herein by reference. The International Application PCT/JP2017/046674 is based upon and claims the benefit of priority of the prior Japanese Patent Application No. 2017-002190, filed on Jan. 10, 2017, the entire contents of which are incorporated herein by reference.

### FIELD

The embodiments discussed herein are related to metadata processing technology.

### BACKGROUND

If program metadata is generated, the metadata can be utilized to, for example, automatically generate another program.

Japanese Laid-open Patent Publication No. 2008-090707 and Japanese Laid-open Patent Publication No. 2011-186929 are disclosed as related art.

### SUMMARY

According to an aspect of the embodiments, a non-transitory computer-readable recording medium stores therein a metadata processing program for causing a computer to execute a process including: extracting, based on comparison between a first input item name of first input data and a first output item name of first output data, an element other than an element included in both of the first input item name and the first output item name; and generating, when the extracted element and an argument of a program which generates the first output data from the first input data include an element related to a first input item value of the first input data, metadata in which the element related to the first input item value in the extracted element is transformed into a variable.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are diagrams illustrating an example of an input table and an output table;

FIG. 2 is a diagram illustrating an example of a table in which metadata is registered;

FIG. 3 is a functional block diagram of a metadata processing apparatus;

FIG. 4 is a diagram illustrating a processing flow of a process of registering metadata;

FIG. 5 is a diagram illustrating an example of the input table;

FIG. 6 is a diagram illustrating an example of the output table;

FIG. 7 is a diagram illustrating an example of template data;

FIG. 8 is a diagram illustrating an example of the template data;

FIG. 9 is a diagram illustrating an example of a function word list;

FIG. 10 is a diagram illustrating an example of the template data;

FIG. 11 is a diagram illustrating an example of the function word list;

FIG. 12 is a diagram illustrating an example of the template data;

FIG. 13 is a diagram illustrating an example of data accumulated in a metadata accumulating part;

FIG. 14 is a diagram illustrating a processing flow of a process of diverting a program to another case by utilizing registered metadata;

FIG. 15 is a diagram illustrating an example of the input table;

FIG. 16 is a diagram illustrating an example of the function word list;

FIG. 17 is a diagram illustrating an example of the format of the output table finally output;

FIG. 18 is a diagram illustrating an example of the template data;

FIG. 19 is a diagram illustrating an example of the function word list;

FIG. 20 is a diagram illustrating an example of the template data;

FIG. 21 is a diagram illustrating an example of the function word list;

FIG. 22 is a diagram illustrating an example of data accumulated in a related item value accumulating part;

FIG. 23 is a diagram illustrating an example of the template data;

FIG. 24 is a diagram illustrating an example of the template data;

FIG. 25 is a diagram illustrating a processing flow of a process of diverting a program to another case by utilizing registered metadata;

FIG. 26 is a diagram illustrating an example of patterns;

FIG. 27 is a diagram illustrating the correspondence relationship between item names included in a pattern and item names included in metadata;

FIG. 28 is a diagram illustrating an example of rearrangement of the columns of the input table;

FIG. 29 is a diagram illustrating an example of a table generated by executing a program;

FIG. 30 is a diagram illustrating the correspondence relationship between item names included in a specified pattern and item names included in the original template data;

FIG. 31 is a diagram illustrating an example of the output table finally generated; and

FIG. 32 is a functional block diagram of a computer.

### DESCRIPTION OF EMBODIMENTS

For example, the more versatile the metadata is, the higher the utility value of the metadata becomes. However, it takes time and effort to create metadata manually.

With regard to the generation of metadata, by analyzing a program itself, metadata of the program is generated. However, analyzing the program itself may not generate appropriate metadata in some cases.

For example, a technology for automatically generating versatile metadata may be provided.

In the following, it is considered to generate metadata of a program that causes a processor to execute a process of outputting a table using data registered in another table as an input.

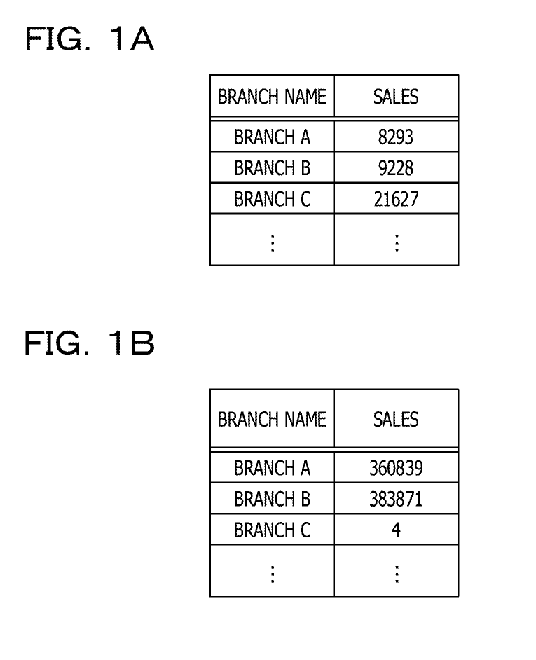

For example, it is assumed that, when a certain program “sum_per_branch” is executed, a table illustrated in FIG. 1B is output using data registered in a table illustrated in FIG. 1A as an input. Focusing on item names of each table, “branch name” exists in both of the tables and “sales” in the table in FIG. 1A is included in “sales by branch” in the table in FIG. 1B.

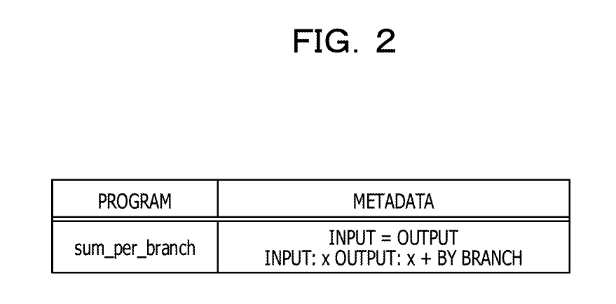

Therefore, metadata as illustrated in FIG. 2 can be generated on the basis of whether or not the item names match. Information regarding a program (in this example, a program name) and metadata are registered in the table illustrated in FIG. 2; the metadata includes information “input=output” indicating that a certain item name in the table in FIG. 1A matches a certain item name in the table in FIG. 1B, and information “input: x output: x+by branch” indicating that a certain item name in the table in FIG. 1A is “x” and a certain item name in the table in FIG. 1B is “x by branch”. If such metadata is prepared, the metadata can be utilized for program maintenance and the like.

However, since the representation of metadata generated as mentioned above is limited, the purpose of utilization is sometimes restricted. In the example in FIG. 2, since the metadata is limited to tabulation by branch, the program is not suitably diverted to the case of performing other tabulation and the like.

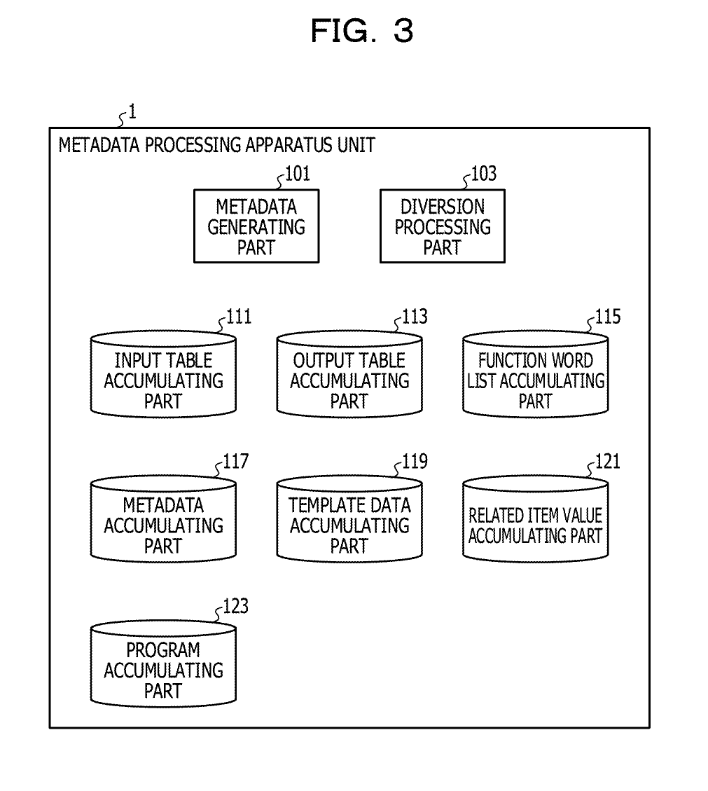

Therefore, in the following, a method of generating more versatile metadata will be described. FIG. 3 illustrates a functional block diagram of a metadata processing apparatus 1 according to the present embodiment. The metadata processing apparatus 1 according to the present embodiment includes a metadata generating part 101, a diversion processing part 103, an input table accumulating part 111, an output table accumulating part 113, a function word list accumulating part 115, a metadata accumulating part 117, a template data accumulating part 119, a related item value accumulating part 121, and a program accumulating part 123.

The metadata generating part 101 executes processes on the basis of an input table accumulated in the input table accumulating part 111, an output table accumulated in the output table accumulating part 113, and program data accumulated in the program accumulating part 123, and accumulates the processing results in the metadata accumulating part 117, the template data accumulating part 119, the function word list accumulating part 115, and the related item value accumulating part 121. The diversion processing part 103 executes processes on the basis of data accumulated in the metadata accumulating part 117, data accumulated in the template data accumulating part 119, and data accumulated in the related item value accumulating part 121, and accumulates the processing results in the output table accumulating part 113.

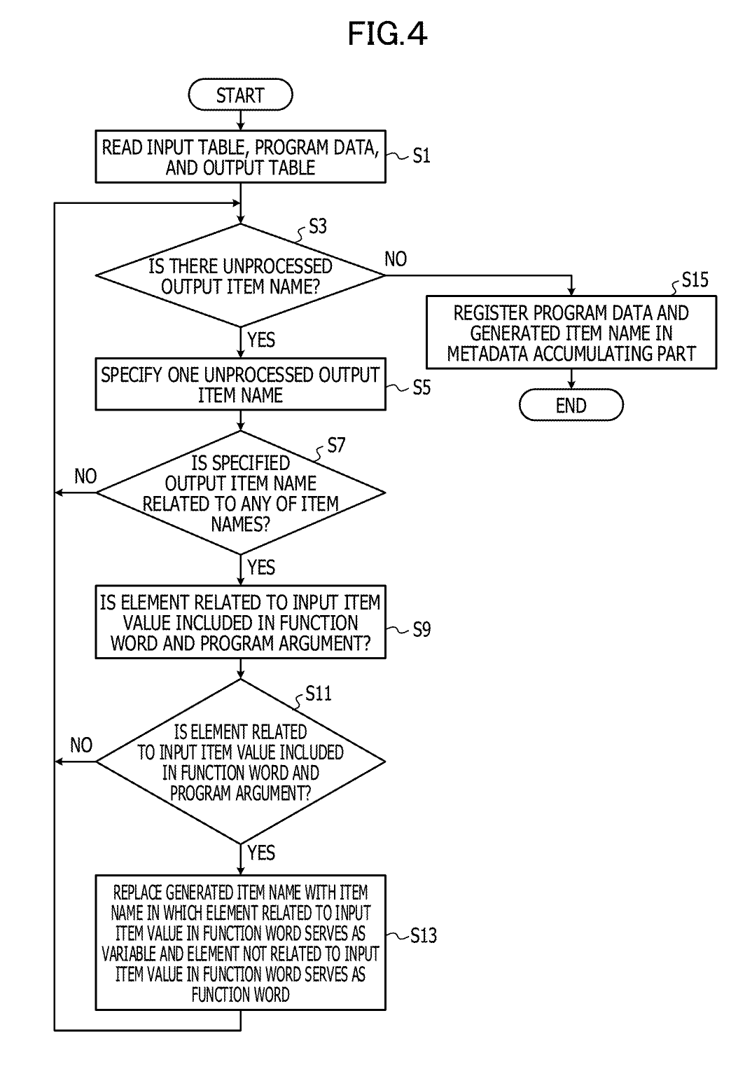

Next, a process executed by the metadata processing apparatus 1 will be described with reference to FIGS. 4 to 31. First, a process of registering metadata will be described with reference to FIGS. 4 to 13.

The metadata generating part 101 reads the input table accumulated in the input table accumulating part 111, the program data accumulated in the program accumulating part 123, and the output table accumulated in the output table accumulating part 113 (FIG. 4: step S1). The program data may be the whole program or may be a part of information included in the program. The program data is, for example, data such as “filter 2 Aida—output year, customer name, number of visits to store”.

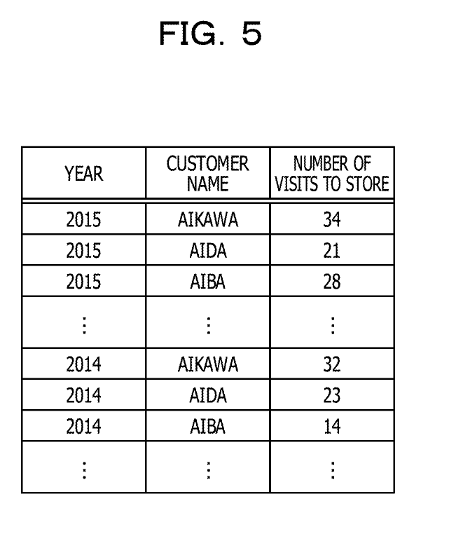

FIG. 5 illustrates an example of the input table. In the example in FIG. 5, data regarding the year, the customer name, and the number of visits to the store is accumulated.

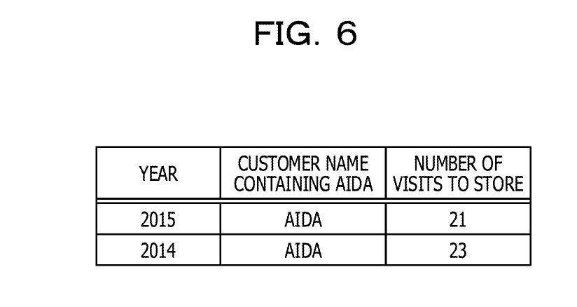

FIG. 6 illustrates an example of the output table. In the example in FIG. 6, data regarding the year, the customer name containing Aida, and the number of visits to the store is accumulated.

The metadata generating part 101 determines whether or not, among the item names of the output table read in step S1 (in the example in FIG. 6, “year”, “customer name containing Aida”, and “number of visits to store”; hereinafter referred to as output item names), there is an unprocessed output item name (step S3).

When there is an unprocessed output item name (step S3: Yes route), the metadata generating part 101 specifies one unprocessed output item name (step S5).

The metadata generating part 101 determines whether or not the output item name specified in step S5 is related to any of the item names of the input table (in the example in FIG. 5, “year”, “customer name”, and “number of visits to store”; hereinafter, referred to as input item names) read in step S1 (step S7). The output item name being related to the input item name means, for example, that the output item name and the input item name are in a perfect match relationship or a partial match relationship.

When the output item name specified in step S5 is not related to any of the input item names read in step S1 (step S7: No route), the process returns to step S3.

On the other hand, when the output item name specified in step S5 is related to one of the input item names read in step S1 (step S7: Yes route), the metadata generating part 101 executes the following process. For example, the metadata generating part 101 specifies an element related to the input item name and an element not related to the input item name in the output item name. Then, the metadata generating part 101 generates an item name in which the element related to the input item name in the output item name serves as a variable and the element not related to the input item name in the output item name serves as a function word (step S9). The metadata generating part 101 accumulates the generated item name in the template data accumulating part 119.

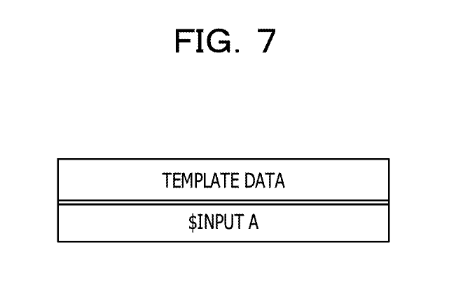

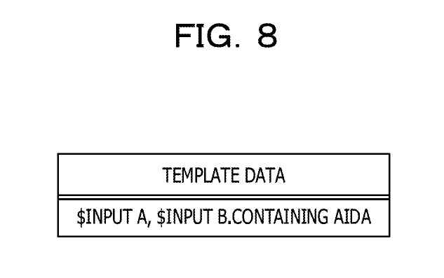

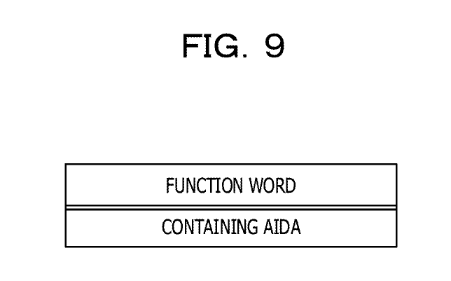

For example, when the output item name is “year” and the input item name is “year”, the element “year” of the output item name is transformed into a variable (parameterized) and, as illustrated in FIG. 7, an item name “$input A” is generated. Likewise, for example, when the input item name is “customer name” and the output item name is “customer name containing Aida”, the element “customer name” of the output item name is transformed into a variable and the element “containing Aida” of the output item name is treated as a function word; as a consequence, an item name “$input B.containing Aida” is generated as illustrated in FIG. 8. Furthermore, the function word “containing Aida” is registered in a function word list accumulated in the function word list accumulating part 115, as illustrated in FIG. 9. In this example, the comma denotes the delimitation between an item name and another item name, while the dot denotes the delimitation between elements of different types (for example, a function word and a variable (for example, a word related to a related item value)). In addition, $input A refers to the first column of the input table and $input B refers to the second column of the input table; in this manner, the alphabetical order corresponds to the position of the column of the input table. Transforming into a variable in the present embodiment means to convert a limited term into an abstracted character, symbol, or the like that is allowed to take various values.

The metadata generating part 101 determines whether or not an element related to the item value (for example, “Aikawa”, “Aida”, and “Aiba”) of the input table read in step S1 is included in the function word specified in step S9 and an argument included in the program data (hereinafter referred to as program argument) read in step S1 (step S11). Note that, when the function word is not specified in step S9, it is determined in step S11 that the result is “No”.

When an element related to the item value of the input table (hereinafter referred to as input item value) read in step S1 is not included in the function word specified in step S9 and the program argument (step S11: No route), the process returns to step S3.

On the other hand, when an element related to the input item value read in step S1 is included in the function word specified in step S9 and the program argument (step S11: Yes route), the metadata generating part 101 executes the following process. For example, the metadata generating part 101 specifies an element related to the input item value and an element not related to the input item value in the function word specified in step S9. Then, the metadata generating part 101 generates an item name in which the element related to the input item value serves as a variable and the element not related to the input item value serves as a function word, and replaces the item name generated in step S9 with the generated item name (step S13). In addition, the metadata generating part 101 corrects the function word registered in the function word list accumulating part 115. The process then returns to step S3.

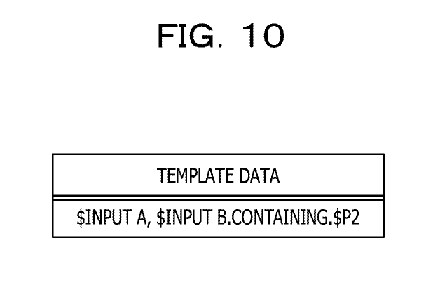

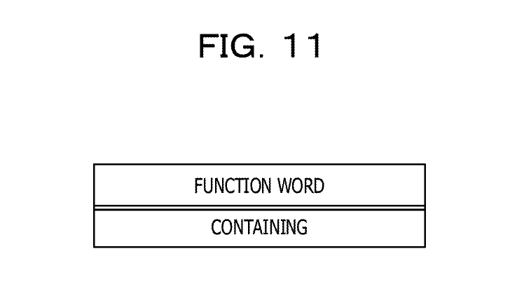

For example, in the example in FIG. 8, the function word “containing Aida” included in the second item name is related to the input item value “Aida” (for example, the function word has a partial match relationship with the input item value “Aida”). Accordingly, for example, when the program data is “filter 2 Aida—output year, customer name, number of visits to store”, the program data is replaced with the item names as illustrated in FIG. 10. Comparing the example in FIG. 10 with the example in FIG. 8, the second item name is changed from “$input B.containing Aida” to “$input B.containing.$P2”. Furthermore, the function word registered in the function word list is modified, for example, from a function word as illustrated in FIG. 9 to a function word as illustrated in FIG. 11.

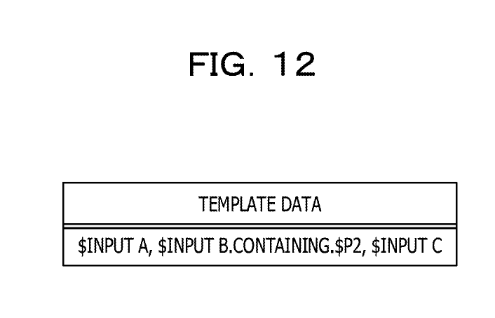

Additionally, once the process is further executed for the output item name “number of visits to store” of the output table illustrated in FIG. 6, for example, template data as illustrated in FIG. 12 is finally generated.

On the other hand, when there is no unprocessed output item name (step S3: No route), the metadata generating part 101 registers the program data read in step S1 and the generated item name (for example, the item name accumulated in the template data accumulating part 119 as template data) in the metadata accumulating part 117 (step S15). The process then ends.

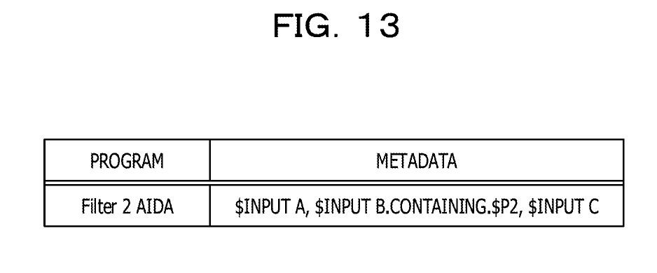

FIG. 13 illustrates an example of data accumulated in the metadata accumulating part 117. In the example in FIG. 13, program data and metadata are accumulated.

As described above, in the present embodiment, the item name of the output table is decomposed into the function word, the element related to the input item name, and the element related to the input item value, and besides, the element also serving as an argument of the program is transformed into a variable. Since the metadata of the program contains a variable, the program is allowed to be utilized in a variety of cases. In the example mentioned above, the program is allowed to be utilized for an extraction process for another input item value different from “Aida”.

Furthermore, as compared with a case where a program is prepared for each type of extraction process, in the method according to the present embodiment, it is sufficient to merely have one program and metadata corresponding to the program. Accordingly, when the number of types of extraction process is several tens or more, taking into account that the data amount of metadata corresponding to one program is usually smaller than the data amount of the program, the data amount is preferably decreased to one several tenths.

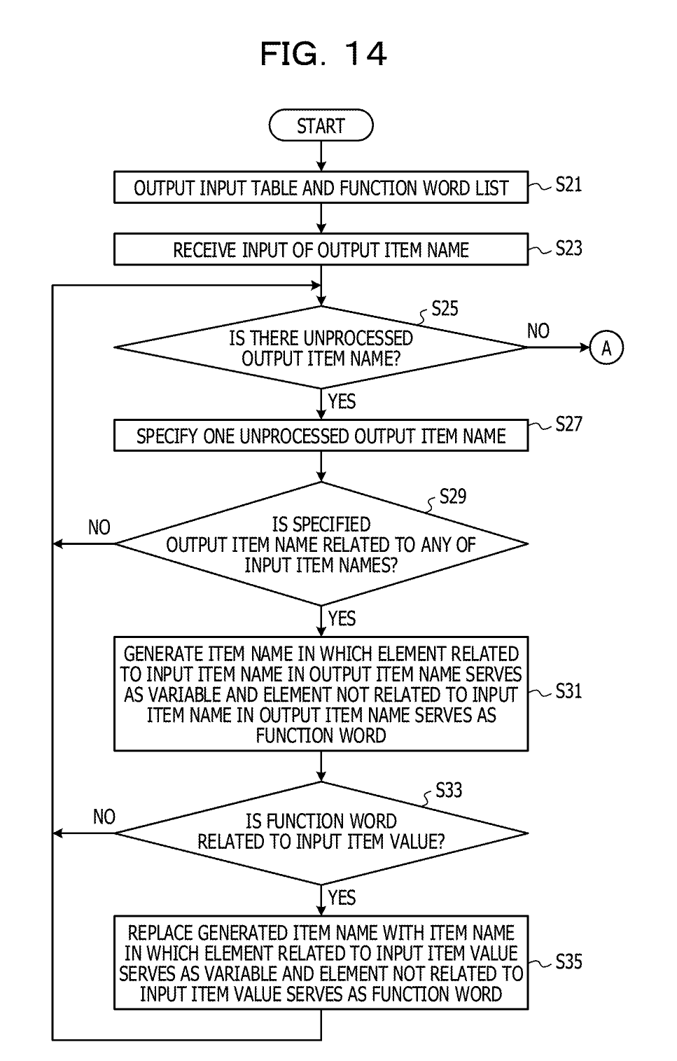

Next, a process of diverting a program to another case by utilizing the registered metadata will be described with reference to FIGS. 14 to 31.

First, the metadata generating part 101 reads the input table accumulated in the input table accumulating part 111 and the function word list accumulated in the function word list accumulating part 115. Then, the metadata generating part 101 outputs the read input table and function word list (FIG. 14: step S21). In step S21, for example, the input table and the function word list are displayed on a display device of the metadata processing apparatus 1.

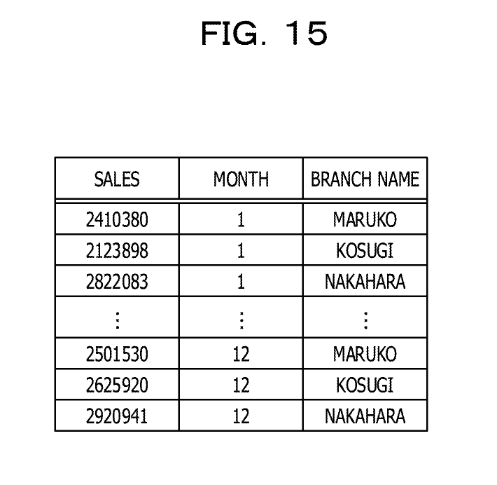

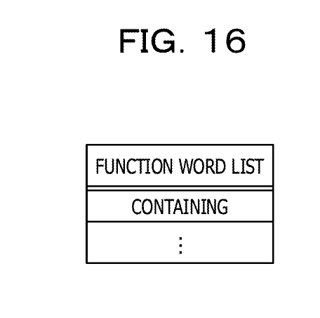

For example, an input table as illustrated in FIG. 15 is output. In the example in FIG. 15, data regarding sales, months, and branch names are registered. In addition, for example, a function word list as illustrated in FIG. 16 is output. It is assumed that one or a plurality of function words is registered in the function word list.

A user who has confirmed the input table and the function word list thinks what kind of output item name is expected to be obtained. Then, the user inputs one or a plurality of output item names using an input device such as a keyboard, a mouse, or a touch panel. Then, the metadata generating part 101 receives an input of the output item name (step S23).

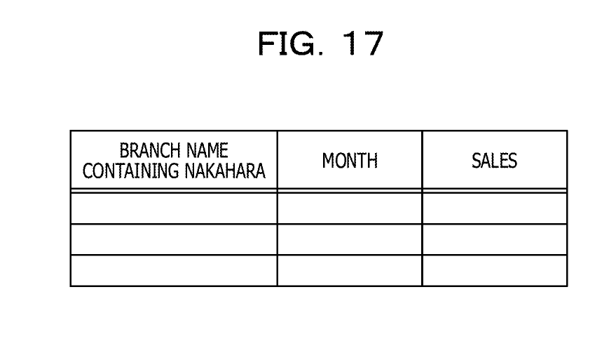

For example, when the user inputs “branch name containing Nakahara”, “month”, and “sales” as output item names, an output table in which data is not filled is generated as illustrated in FIG. 17.

The metadata generating part 101 determines whether or not there is an unprocessed output item name among the output item names of which inputs have been received in step S23 (step S25).

When there is an unprocessed output item name (step S25: Yes route), the metadata generating part 101 specifies one unprocessed output item name (step S27).

The metadata generating part 101 determines whether or not the output item name specified in step S27 is related to any of the input item names of the input table displayed in step S21 (in the example in FIG. 15, “sales”, “month”, and “branch name”) (step S29). The output item name being related to the input item name means, for example, that the output item name and the input item name are in a perfect match relationship or a partial match relationship.

When the output item name specified in step S27 is not related to any of the input item names of the input table displayed in step S21 (step S29: No route), the process returns to step S25.

On the other hand, when the output item name specified in step S27 is related to one of the input item names of the input table displayed in step S21 (step S29: Yes route), the metadata generating part 101 executes the following process. For example, the metadata generating part 101 specifies an element related to the input item name and an element not related to the input item name in the output item name. Then, the metadata generating part 101 generates an item name in which the element related to the input item name in the output item name serves as a variable and the element not related to the input item name in the output item name serves as a function word (step S31). The metadata generating part 101 accumulates the generated item name in the template data accumulating part 119.

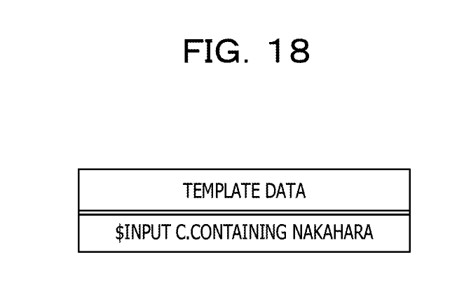

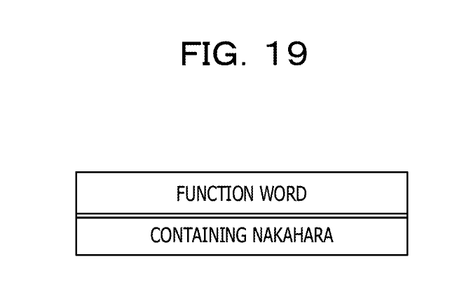

For example, when the input item name is “branch name” and the output item name is “branch name containing Nakahara”, the element “branch name” of the output item name is transformed into a variable and the element “containing Nakahara” of the output item name is treated as a function word; as a consequence, an item name “$input C.containing Nakahara” is generated as illustrated in FIG. 18. Furthermore, the function word “containing Nakahara” is registered in the function word list accumulated in the function word list accumulating part 115, as illustrated in FIG. 19.

The metadata generating part 101 determines whether or not the function word specified in step S31 is related to the input item value of the input table displayed in step S21 (for example, “Maruko”, “Kosugi”, and “Nakahara”) (step S33). Note that, when the function word is not specified in step S31, it is determined in step S33 that the result is “No”.

When the function word specified in step S31 is not related to the input item value of the input table displayed in step S21 (step S33: No route), the process returns to step S25.

On the other hand, when the function word specified in step S31 is related to the input item value of the input table displayed in step S21 (step S33: Yes route), the metadata generating part 101 executes the following process. For example, the metadata generating part 101 specifies an element related to the input item value and an element not related to the input item value in the function word specified in step S31. Then, the metadata generating part 101 generates an item name in which the element related to the input item value serves as a variable and the element not related to the input item value serves as a function word, and replaces the item name generated in step S31 with the generated item name (step S35). In addition, the metadata generating part 101 corrects the function word registered in the function word list accumulating part 115 and accumulates the input item value determined to be related (for example, the related item value) in the related item value accumulating part 121. The process then returns to step S25.

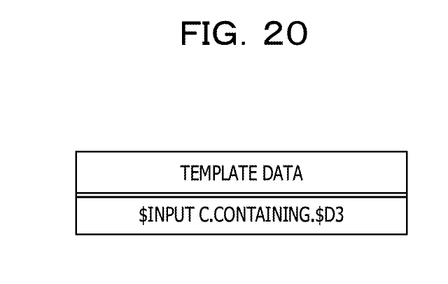

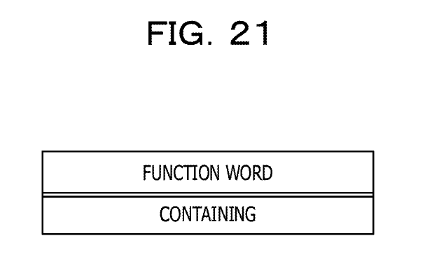

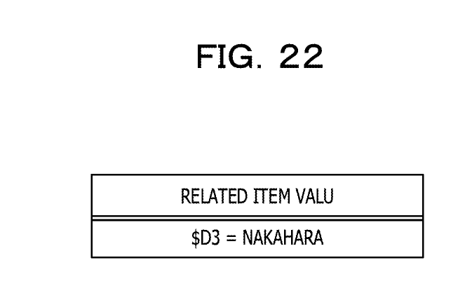

For example, in FIG. 18, the function word “containing Nakahara” included in the item name is related to the input item value “Nakahara” (for example, the function word has a partial match relationship with the input item value “Nakahara”). Accordingly, the item name generated in step S31 is replaced with an item name as illustrated in FIG. 20. Comparing the example in FIG. 20 with the example in FIG. 18, the item name is changed from “$input C.containing Nakahara” to “$input C.containing.$D3”. Furthermore, the function word registered in the function word list is modified, for example, from a function word as illustrated in FIG. 19 to a function word as illustrated in FIG. 21. In addition, for example, the related item value as illustrated in FIG. 22 is accumulated in the related item value accumulating part 121.

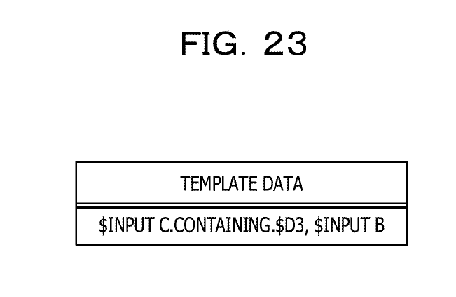

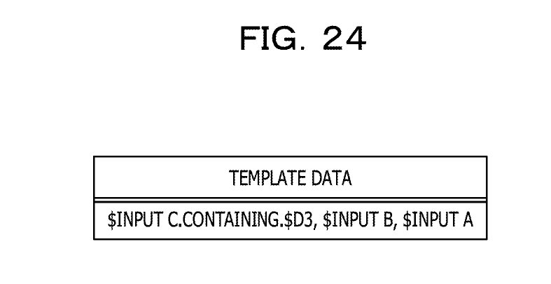

Additionally, once the process is further executed for the output item name “month” of the output table illustrated in FIG. 17, for example, template data as illustrated in FIG. 23 is generated. Likewise, once the process is further executed for the output item name “sales” of the output table illustrated in FIG. 17, for example, template data as illustrated in FIG. 24 is generated.

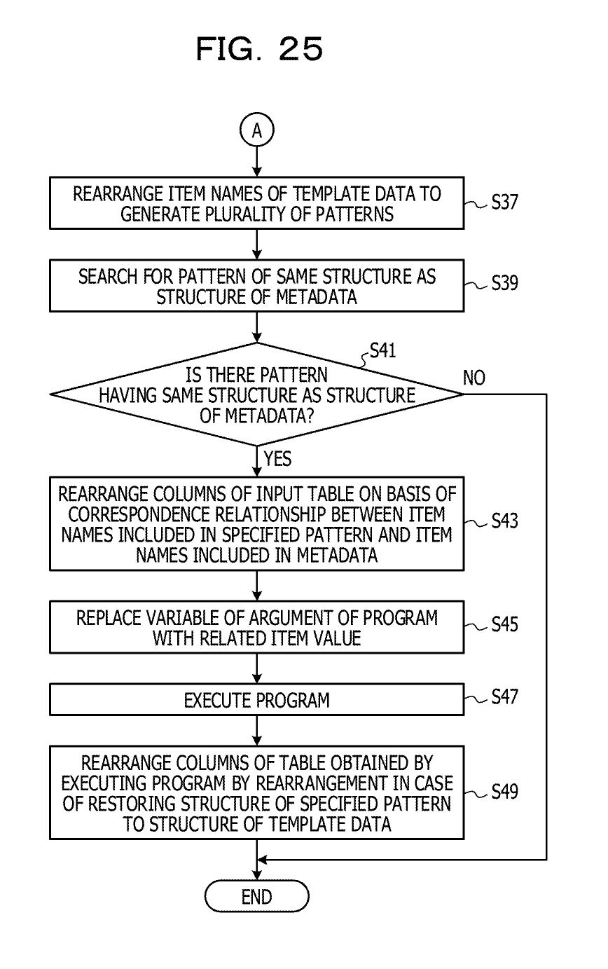

On the other hand, when there is no unprocessed output item name (step S25: No route), the process shifts to step S37 in FIG. 25 via the terminal A.

Shifting to the description of FIG. 25, the diversion processing part 103 rearranges the item names included in the template data generated by the process in steps S21 to S35 to generate a plurality of patterns (FIG. 25: step S37). Then, the diversion processing part 103 searches for a pattern of the same structure as the structure of the metadata accumulated in the metadata accumulating part 117 from among the plurality of patterns (step S39).

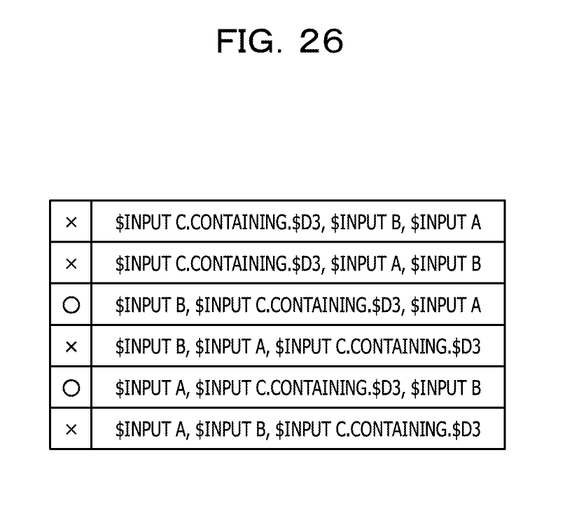

For example, when the item name rearrangement is executed on the template data illustrated in FIG. 24, six patterns as illustrated in FIG. 26 are generated. For example, when the metadata illustrated in FIG. 13 is accumulated in the metadata accumulating part 117, the structure of the third template data and the structure of the fifth template data match the structure of the metadata. The structure means the order of arrangement of the input item values, the variables, the function words, and the like. In this embodiment, for example, $input A and $input B are treated as the same, and $P2 and $D3 are treated as the same.

The diversion processing part 103 determines whether or not there is a pattern having the same structure as the structure of the metadata (step S41). When there is no pattern having the same structure as the structure of the metadata (step S41: No route), the process ends because there is no divertable program.

On the other hand, when there is a pattern having the same structure as the structure of the metadata (step S41: Yes route), the diversion processing part 103 specifies one pattern having the same structure as the structure of the metadata and executes the following process. For example, the diversion processing part 103 rearranges the columns of the input table on the basis of the correspondence relationship between the item names included in the specified pattern and the item names included in the metadata (step S43).

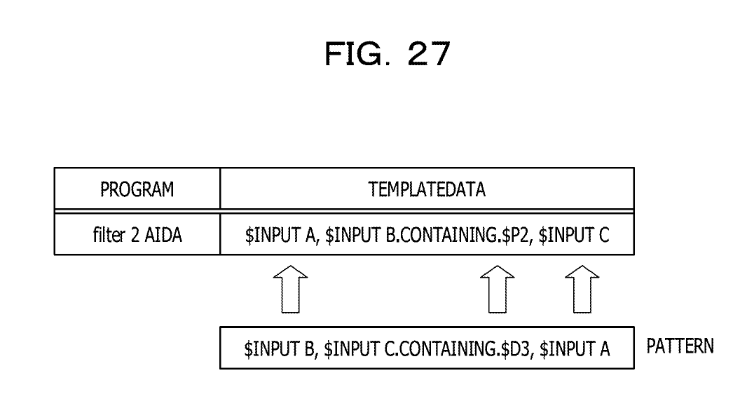

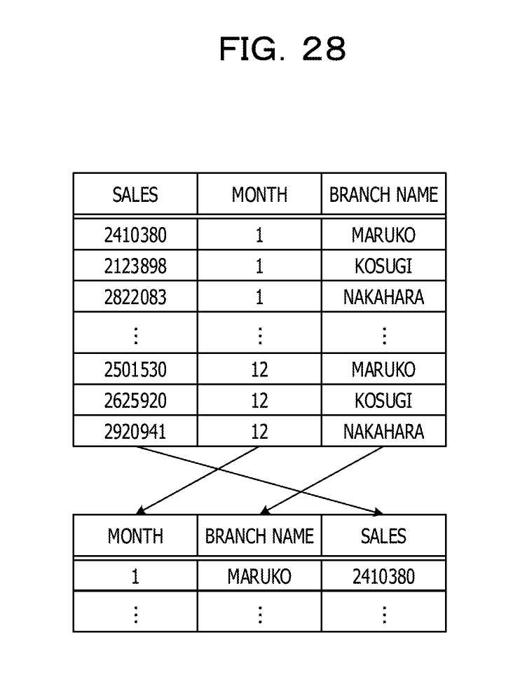

For example, as illustrated in FIG. 27, when the specified pattern is “$input B, $input C.containing.$D3, $input A” and the metadata is “$input A, $input B.containing.$P2, $input C”, $input B of the pattern corresponds to $input A of the metadata, $input C of the pattern corresponds to $input B of the metadata, and $input A of the pattern corresponds to $input C of the metadata. In this case, as illustrated in FIG. 28, the first column of the input table displayed in step S21 is changed to the third column, the second column is changed to the first column, and the third column is changed to the second column. By this process, the input table displayed in step S21 is allowed to be used as an input of the program corresponding to the metadata.

The diversion processing part 103 reads the program data accumulated in the metadata accumulating part 117 and replaces an argument (in this case, an argument associated with the input item value) included in the read program data with the related item value accumulated in the related item value accumulating part 121 (step S45). For example, the argument “Aida” in the program data “filter 2 Aida” is substituted with “Nakahara”. By this process, the original program is allowed to be executed in this case.

The diversion processing part 103 executes the program with the program data whose argument has been replaced in step S45, with respect to the input table whose columns have been rearranged in step S43 (step S47).

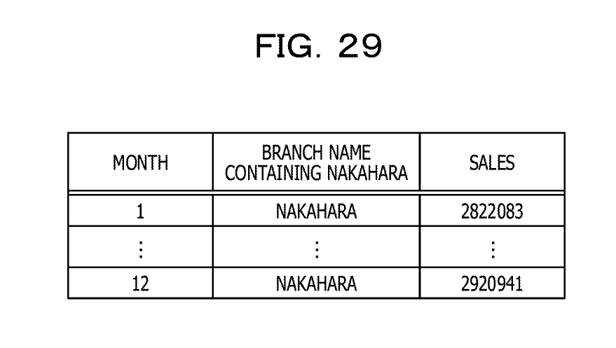

By the process in step S47, for example, a table as illustrated in FIG. 29 is generated. In the example in FIG. 29, data regarding the month, branch names including Nakahara, and sales are accumulated. The table illustrated in FIG. 29 is not a final output table because, as compared with the table in FIG. 17, the positions of the columns are different between the two tables.

The diversion processing part 103 rearranges the columns of the table generated by the process in step S47 by the rearrangement in the case of restoring the structure of the specified pattern to the structure of the original template data (step S49). The diversion processing part 103 accumulates the output table generated by the process in step S49 in the output table accumulating part 113. The process then ends.

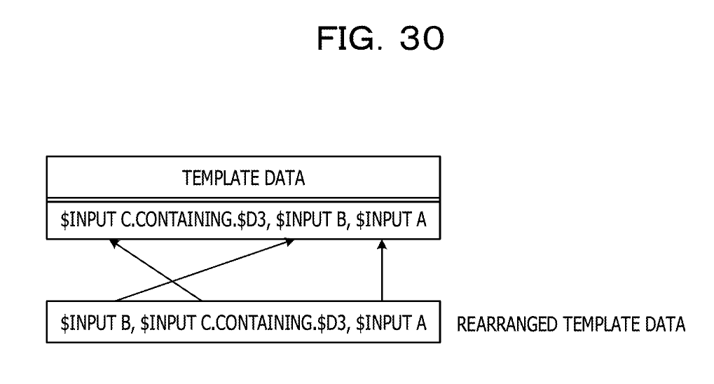

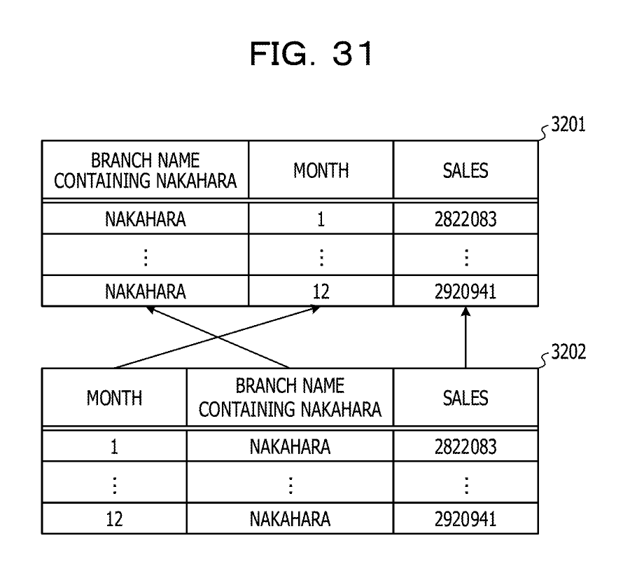

For example, as illustrated in FIG. 30, it is assumed that the first item name of the rearranged template data corresponds to the second item name of the original template data, the second item name of the rearranged template data corresponds to the first item name of the original template data, and the third item name of the rearranged template data corresponds to the third item name of the original template data. In this case, as illustrated in FIG. 31, a final output table 3201 is obtained by performing rearrangement such that the first column of a table 3202 generated by the process in step S47 is moved to the second column, the second column of the table 3202 is moved the first column, and the third column of the table 3202 is moved to the third column.

By executing the above-described process, a certain process of generating an output table from an input table is properly implemented by an existing program, and the time and effort expected to create a program from scratch is preferably reduced.

Although the embodiments of the present invention have been described thus far, the present invention is not limited to these embodiments. For example, the functional block configuration of the metadata processing apparatus 1 described above may not match the actual program module configuration.

Furthermore, the configuration of each table described above is an example and the configuration is not necessarily as described above. In the processing flow, it is also practicable to exchange the order of processes as long as the processing result does not change. The processes may be executed in parallel.

The present embodiments may be applied not to the extraction process but to another process (for example, a substitution process of substituting an item value with another value).

The method of representing the variables, the template data, and the like is not limited to the example indicated above.

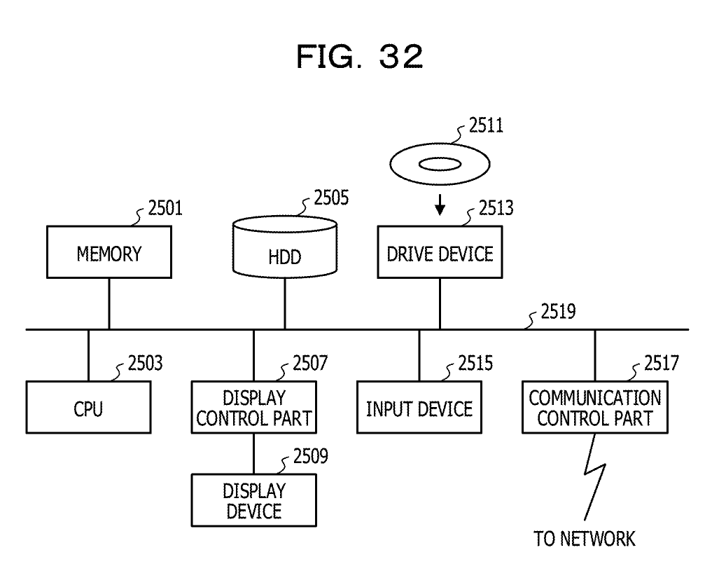

The metadata processing apparatus 1 described above is a computer apparatus and, as illustrated in FIG. 32, a memory 2501, a central processing unit (CPU) 2503, a hard disk drive (HDD) 2505, a display control part 2507 connected to a display device 2509, a drive device 2513 for a removable disk 2511, an input device 2515, and a communication control part 2517 for connecting to a network are connected by a bus 2519. An operating system (OS) and an application program for carrying out the process in the present working example are accumulated in the HDD 2505 and read from the HDD 2505 to the memory 2501 when executed by the CPU 2503. The CPU 2503 controls the display control part 2507, the communication control part 2517, and the drive device 2513 according to the processing content of the application program and causes these members to perform a predetermined operation. Data in the middle of processing is mainly accumulated in the memory 2501 but may be accumulated in the HDD 2505. In the working example of the present invention, the application program for carrying out the above-described process is accumulated in the computer readable removable disk 2511 to be distributed and installed in the HDD 2505 from the drive device 2513. There is also a case where the application program is installed in the HDD 2505 by way of a network such as the Internet and the communication control part 2517. Such a computer apparatus implements various types of functions as mentioned above by organic cooperation between hardware such as the CPU 2503 and the memory 2501 and programs such as the OS and the application program mentioned above.

The embodiments of the present invention described thus far are summarized as follows.

A metadata processing method according to a first mode of the present embodiment includes: (A) extracting an element other than an element included in both of an item name of first input data and an item name of first output data, on the basis of comparison between item names of the first input data and item names of the first output data; and (B) generating, when the extracted element and an argument of a program for generating the first output data from the first input data include an element related to an item value of the first input data, metadata in which the element related to the item value of the first input data in the extracted element is transformed into a variable.

The metadata becomes more versatile because the metadata contains a variable.

In the generating the metadata, (b1) metadata in which an element related to an item value of the first input data in the extracted element is transformed into a variable, and an element included in both of an item name of the first input data and an item name of the first output data is transformed into a variable may be generated.

The metadata becomes more versatile because a part of the metadata is further transformed into a variable.

The present metadata processing method may further include: (C) extracting an element other than an element included in both of an item name of second input data and a designated item name, on the basis of comparison between the item name of the second input data and the designated item name; (D) generating, when the extracted element includes an element related to an item value of the second input data, template data in which the element related to the item value of the second input data in the extracted element is transformed into a variable; (E) rearranging columns of the second input data on the basis of a correspondence relationship between elements included in the metadata and elements included in the template data; and (F) executing the program with the second input data of which the columns have been rearranged, as an input to generate second output data.

The program is allowed to be diverted to a process of other input data

In the rearranging the columns of the second input data, (e1) item names included in the template data may be rearranged such that a format of the metadata matches a format of the template data, and the columns of the second input data may be rearranged on the basis of a correspondence relationship between elements included in the metadata and elements included in the template data of which the item names have been rearranged. The present metadata processing method may further include (G) executing the same rearrangement as rearrangement in the case of restoring an arrangement of the item names included in the template data to an original arrangement, with respect to the columns of the second output data.

It becomes easier to cope with a case where the format of the metadata and the format of the template data are different from each other.

A metadata processing apparatus according to a second mode of the present embodiment includes: (H) a data accumulating part (for example, the input table accumulating part 111 and the output table accumulating part 113) that accumulates first input data and first output data; and (I) a generating part (for example, the metadata generating part 101) that extracts an element other than an element included in both of an item name of the first input data and an item name of the first output data, on the basis of comparison between item names of the first input data and item names of the first output data, and, when the extracted element and an argument of a program for generating the first output data from the first input data include an element related to an item value of the first input data, generates metadata in which the element related to the item value of the first input data in the extracted element is transformed into a variable.

A program for causing a computer to execute the process according to the above method can be created, and the program is accumulated in, for example, a computer readable storage medium or storage device, such as a flexible disk, a compact disk read only memory (CD-ROM), a magneto-optical disk, a semiconductor memory, or a hard disk. An intermediate processing result is temporarily saved in a storage device such as a main memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a metadata processing program for causing a computer to execute a process comprising:
extracting, based on comparison between a first input item name of first input data and a first output item name of first output data, an element other than an element included in both of the first input item name and the first output item name; and
generating, when the extracted element and an argument of a program which generates the first output data from the first input data include an element related to a first input item value of the first input data, metadata in which the element related to the first input item value in the extracted element is transformed into a variable.

2. The non-transitory computer-readable recording medium according to claim 1, wherein
in the generating the metadata,
the metadata in which the element related to the first input item value in the extracted element is transformed into a variable, and the element included in both of the first input item name and the first output item name is transformed into a variable is generated.

3. The non-transitory computer-readable recording medium according to claim 1, wherein the process further includes:
extracting, based on comparison between a second input item name of second input data and a specified item name, an element other than an element included in both of the second input item name and the specified item name;
generating, when the extracted element includes an element related to a second input item value of the second input data, template data in which the element related to the second input item value in the extracted element is transformed into a variable;
rearranging columns of the second input data based on a correspondence relationship between elements included in the metadata and elements included in the template data; and
executing the program with the second input data of which the columns are rearranged as an input to generate second output data.

4. The non-transitory computer-readable recording medium according to claim 3, wherein
in the rearranging the columns of the second input data,
item names included in the template data are rearranged such that a format of the metadata matches a format of the template data, and the columns of the second input data are rearranged on the basis of a correspondence relationship between the elements included in the metadata and the elements included in the template data of which the item names are rearranged,
wherein the processing further includes executing the same rearrangement as rearrangement when restoring an arrangement of the item names included in the template data to an original arrangement, with respect to the columns of the second output data.

5. A metadata processing method comprising:
extracting, by a computer, based on comparison between a first input item name of first input data and a first output item name of first output data, an element other than an element included in both of the first input item name and the first output item name; and
generating, when the extracted element and an argument of a program which generates the first output data from the first input data include an element related to a first input item value of the first input data, metadata in which the element related to the first input item value in the extracted element is transformed into a variable.

6. The metadata processing method according to claim 5, wherein
in the generating the metadata,
the metadata in which the element related to the first input item value in the extracted element is transformed into a variable, and the element included in both of the first input item name and the first output item name is transformed into a variable is generated.

7. The metadata processing method according to claim 5, further comprising:
extracting, based on comparison between a second input item name of second input data and a specified item name, an element other than an element included in both of the second input item name and the specified item name;
generating, when the extracted element includes an element related to a second input item value of the second input data, template data in which the element related to the second input item value in the extracted element is transformed into a variable;
rearranging columns of the second input data based on a correspondence relationship between elements included in the metadata and elements included in the template data; and
executing the program with the second input data of which the columns are rearranged as an input to generate second output data.

8. The metadata processing method according to claim 7, wherein
in the rearranging the columns of the second input data,
item names included in the template data are rearranged such that a format of the metadata matches a format of the template data, and the columns of the second input data are rearranged on the basis of a correspondence relationship between the elements included in the metadata and the elements included in the template data of which the item names are rearranged,
wherein the method further includes executing the same rearrangement as rearrangement when restoring an arrangement of the item names included in the template data to an original arrangement, with respect to the columns of the second output data.

9. An information processing apparatus comprising:
a memory; and
a processor coupled to the memory and configured to execute a process of:
extracting, based on comparison between a first input item name of first input data and a first output item name of first output data, an element other than an element included in both of the first input item name and the first output item name; and
generating, when the extracted element and an argument of a program which generates the first output data from the first input data include an element related to a first input item value of the first input data, metadata in which the element related to the first input item value in the extracted element is transformed into a variable.

10. The information processing apparatus according to claim 9, wherein
in the generating the metadata,
the metadata in which the element related to the first input item value in the extracted element is transformed into a variable, and the element included in both of the first input item name and the first output item name is transformed into a variable is generated.

11. The information processing apparatus according to claim 9, wherein the process further includes:
extracting, based on comparison between a second input item name of second input data and a specified item name, an element other than an element included in both of the second input item name and the specified item name;
generating, when the extracted element includes an element related to a second input item value of the second input data, template data in which the element related to the second input item value in the extracted element is transformed into a variable;
rearranging columns of the second input data based on a correspondence relationship between elements included in the metadata and elements included in the template data; and
executing the program with the second input data of which the columns are rearranged as an input to generate second output data.

12. The information processing apparatus according to claim 11, wherein
in the rearranging the columns of the second input data,
item names included in the template data are rearranged such that a format of the metadata matches a format of the template data, and the columns of the second input data are rearranged on the basis of a correspondence relationship between the elements included in the metadata and the elements included in the template data of which the item names are rearranged,
wherein the processing further includes executing the same rearrangement as rearrangement when restoring an arrangement of the item names included in the template data to an original arrangement, with respect to the columns of the second output data.
